(19) United States
(12) Patent Application Publication
(10) Pub. No.: US 2014/0284478 A1
(43) Pub. Date: Sep. 25, 2014

(54) X-RAY ANALYZING APPARATUS

(71) Applicant: RIGAKU CORPORATION, Tokyo (JP)

(72) Inventors: Yukio SAKO, Takatsuki-shi (JP); Kosuke KAWAKYU, Takatsuki-shi (JP)

(73) Assignee: RIGAKU CORPORATION, Tokyo (JP)

(21) Appl. No.: 14/222,806

(22) Filed: Mar. 24, 2014

(30) Foreign Application Priority Data
Mar. 25, 2013 (JP) 2013-061644

(51) Int. Cl. G01T 1/16

(52) U.S. Cl. CPC G01T 1/16
USPC 250/336.1

(57) ABSTRACT

Conjointly provided are a first correcting unit (13A, 13B) to estimate, on the basis of the whole sum of counting rates determined by a counting unit (10A, 10B), a peak position in an energy spectrum obtained in the counting unit (10A, 10B) and to output an initial value which is a gain value required to render the estimated peak position to coincide with a reference position, and a second correcting unit (14A, 14B) to detect, in the energy spectrum obtained in the counting unit (10A, 10B), the peak position within a predetermined energy range containing the reference position and to output a dynamic gain correction value which is a gain value required to render the detected peak position to coincide with the reference position.

### CROSS REFERENCE TO THE RELATED APPLICATION

This application is based on and claims Convention priority to Japanese patent application No. 2013-061644, filed Mar. 25, 2013, the entire disclosure of which is herein incorporated by reference as a part of this application.

### BACKGROUND OF THE INVENTION

1. Field of the Invention

The present invention relates to an X-ray analyzing apparatus in which a so-called peak shift is corrected.

2. Description of Related Art

Heretofore in, for example, a wavelength dispersive X-ray fluorescence spectrometer, a sample is irradiated with primary X-rays, fluorescent X-rays emitted from the sample are then monochromated by a spectroscopic device and the monochromated fluorescent X-rays are subsequently detected by a detector to generate pulses. The voltage of these pulses so outputted from the detector, that is, the pulse height value depends on the energy of the fluorescent X-rays and is, more specifically, considered to be proportional thereto. Also, the number of the pulses per unit time depends on the intensity of the fluorescent X-rays. Accordingly, some of those pulses, which fall within a predetermined voltage range (defined by uppermost and lowermost limits and being generally referred to as a “window”) are selected with the use of a pulse height analyzer and the resultant counting rate (the number of pulses per unit time) is then determined by means of a counting unit such as, for example, a scaler, with such counting rate taken as the intensity of the X-rays.

It has, however, been found that where as the detector is used in the form of, for example, a proportional counter, in the event that the fluorescent X-rays of a high intensity are received by the detector, the voltage, that is, pulse height of the pulses to be fed to the pulse height analyzer abruptly decrease by some 10% in a few seconds or, depending on the circumstances, subsequently, for example, for a ten and some minutes after the decrease of the pulse height value, it becomes unstable within a range of about a few percents. This phenomenon is referred to as the peak shift or the drift of the pulse height, and once this peak shift occurs, the measurement would take place with the improper window which has been diverted relative to the target wavelength, failing to achieve an accurate analysis. (In this connection, see the patent documents 1 to 4 listed below). This problem tends to occur even with an X-ray analyzing apparatus other than the wavelength dispersive X-ray fluorescence spectrometer and, also, to occur in varying degrees during the use of a detector other than the proportional counter. (In this respect, see the patent documents 3 and 4 listed below.).

In view of the foregoing, as the first conventional technique for correcting the peak shift, suggestion (See the patent documents 1 and 2 listed below.) has been made that during the preparatory measurement the peak position is estimated based on the intensity of the X-rays determined by the counting unit, but during the actual measurement the gain of pulses from the detector is altered so that the estimated peak position may coincide with a reference position corresponding to the original pulse height. In this case, the relation between the intensity of the X-rays, determined by the counting unit, and the peak position in the energy spectrum, which has been lowered and stabilized, is beforehand determined by means of a series of experiments. Also, as the second conventional technique for correcting the peak shift, an apparatus has been known, in which the energy spectrum is obtained by means of the counting unit, the peak position is detected within a predetermined energy range including the reference position and the gain of the pulses from the detector is dynamically altered (in real time) so that the detected peak position may coincide with the reference position. (In this connection, see the patent documents 3 and 4 listed below.

### [Prior Art Literature]

[Patent Document 1] JP Laid-open Patent Publication No. S58-187885

[Patent Document 2] JP Laid-open Patent Publication No. 2005-9861

[Patent Document 3] JP Laid-open Patent Publication No. H06-130155

[Patent Document 4] JP Examined Patent Publication No. S62-12475

It has however been found that a few seconds, in the case of the smallest possible length of time required, is required for the peak position, which has been lowered as a result of the peak shift, to stabilize. Accordingly, if the actual measurement is initiated by applying the first mentioned conventional technique, before the peak position comes to stabilize, so that the peak position can be estimated, and then correcting the peak position with the gain altered, the corrected peak position lies at a position higher than the reference position, which corresponds to the original pulse height, and, therefore, no accurate analysis is possible during a time span in which the peak position is lowered and is then stabilized. Notwithstanding, if for the purpose of the accurate measurement the initiation of the actual measurement is delayed by the time the peak position, which is lowered as a result of the peak shift, comes to stabilize, a wait must be made for a few seconds in the case of the smallest possible length of time required and, therefore, the analysis requires a corresponding length of time to complete. Where instability that lasts for a ten and some minutes subsequent to the abrupt lowering of the pulse height, it is further difficult to complete the accurate analysis in a short length of time. Also, since the relation between the intensity of the X-ray, determined by the counting unit, and the peak position in the energy spectrum that has been lowered and stabilized varies delicately with individual X-ray analyzing apparatuses, verification of those X-ray analyzing apparatuses based on a series of experiments that are conducted beforehand is needed for the accurate measurement to be accomplished and, in the event that a detector is replaced in each of those X-ray analyzing apparatuses, the replaced detector after replacement must also be verified.

On the other hand, according to the second mentioned conventional technique, there is the risk that abrupt change of the X-ray intensity makes it difficult to find the peak position enough to render it difficult to achieve an accurate detection of the peak position, thus failing to achieve the accurate analysis.

### SUMMARY OF THE INVENTION

In view of the foregoing, the present invention has for its primary object to provide an X-ray analyzing apparatus capable of accomplishing an accurate analysis in a short length of time, in which any possible occurrence of the peak shift can be quickly and properly corrected.

In order to accomplish the foregoing object of the present invention, there is, in accordance with the present invention, provided an X-ray analyzing apparatus which includes a detector to generate pulses of a pulse height, corresponding to an energy of X-rays incident thereupon, in a number corresponding to an intensity of the X-rays; a high speed analog-to-digital converter to digitize the pulses generated by the detector; a counting unit to calculate the intensity of the X-rays on the basis of an energy spectrum representing a distribution of counting rates relative to the pulse heights, which is obtained by determining the counting rates of pulses from the high speed analog-to-digital converter, which are classified for a plurality of continuous pulse height ranges; and a peak position stabilizing unit to stabilize a peak position in the energy spectrum with respect to the pulses from the high speed analog-to-digital converter.

And, the peak position stabilizing unit referred to above in turn includes an input pulse multiplier to which the pulses from the high speed analog-to-digital converter are inputted, the input pulse multiplier providing an output by changing a gain; a first correcting unit to estimate the peak position in the energy spectrum on the basis of a whole sum of the counting rates determined by the counting unit and then to output an initial value, which is a gain value required to render the peak position, so estimated, to coincide with a reference position; a second correcting unit to detect the peak position in the energy spectrum, obtained in the counting unit, within a predetermined energy range containing the reference position, and to output a dynamic gain correction value, which is a gain value required to render the peak position, so detected, to coincide with the reference position; and a gain adder to which the initial value and the dynamic gain correction value are inputted, the gain adder to add the both together and then to output them to the input pulse multiplier.

According to the present invention, not only is a multi-channel analyzer provided as the counting unit, but also in the peak position stabilizing unit, there are provided the first correcting unit to estimate the peak position in the energy spectrum obtained in the counting unit on the basis of the whole sum of the counting rates determined by the counting unit and to output the initial value which is the gain value required to render the estimated peak position to coincide with the reference position, and the second correcting unit to detect the peak position in the energy spectrum, obtained in the counting unit, within the predetermined energy range containing the reference position, and to output the dynamic gain correction value, which is the gain value required to render the peak position, so detected, to coincide with the reference position, and even though the peak shift occurs, the initial value is outputted in an extremely short length of time and the dynamic gain correction value is added thereto and is adjusted by means of a feedback. Accordingly, there is no necessity to wait for the start of the actual measurement until the peak position, which is lowered as a result of the peak shift, is stabilized, and due to the initial value being outputted the peak position can be accurately detected without losing it in determining the dynamic gain correction value. Therefore, even though the peak shift occurs, the correction can be made quickly and properly and the accurate analysis can be accomplished in a short length of time.

In a preferred embodiment of the present invention, the peak position stabilizing unit referred to above may include a zero position correcting unit to detect a zero peak position, at which no event level frequency peak within a predetermined energy range containing a zero reference position corresponding to a zero pulse height in the energy spectrum obtained in the counting unit and to output the zero position gain value required to render the zero peak position, so detected, to coincide with the zero reference position; and a zero position adder disposed between the high speed analog-to-digital converter and the input pulse multiplier and to which the pulses from the high speed analog-to-digital converter and the zero position gain value are inputted, the zero position adder operable to add the zero position gain value to the pulses from the high speed analog-to-digital converter and then to output it to the input pulse multiplier. In this case, since even a deviation in the zero position corresponding to the zero pulse height can be corrected, a further accurate analysis can be accomplished.

In another preferred embodiment of the present invention, where the detector referred to above is employed in the form of a gas flow proportional counter, the peak position stabilizing unit referred to above preferably includes a temperature sensor to measure a temperature of the detector and/or a pressure sensor to measure a gas pressure of the detector; a gas density correcting unit to estimate the peak position in the energy spectrum on the basis of the temperature measured by the temperature sensor, and/or the pressure measured by the pressure sensor and then to output a gas density gain coefficient required to render the estimated peak position to coincide with the reference position; and an initial value multiplier disposed between the first correcting unit and the gain adder and to which the initial value and the gas density gain coefficient are inputted, the initial value multiplier operable to multiply the initial value by the gas density gain coefficient and then to output it to the gain adder. In this case, since a deviation in the peak position resulting from a change of the gas density of the detector which is the gas flow proportional counter, that is, a deviation in the peak position resulting from a change of the detector temperature and/or the gas pressure of the detector is corrected without the use of a mechanical gas density stabilizer and the initial value is then outputted, the peak position, when the dynamic gain correction value is determined, can be further accurately detected without losing it and a further accurate analysis can therefor be accomplished in a simplified manner.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a schematic diagram showing a wavelength dispersive X-ray fluorescence spectrometer designed in accordance with a preferred embodiment of the present invention;

FIG. 2 is a block diagram showing a peak position stabilizing unit employed in the X-ray fluorescence spectrometer shown in FIG. 1; and

FIG. 3 is a diagram showing one example of the energy spectrum obtained by the X-ray fluorescence spectrometer shown in FIG. 1.

### DESCRIPTION OF PREFERRED EMBODIMENTS

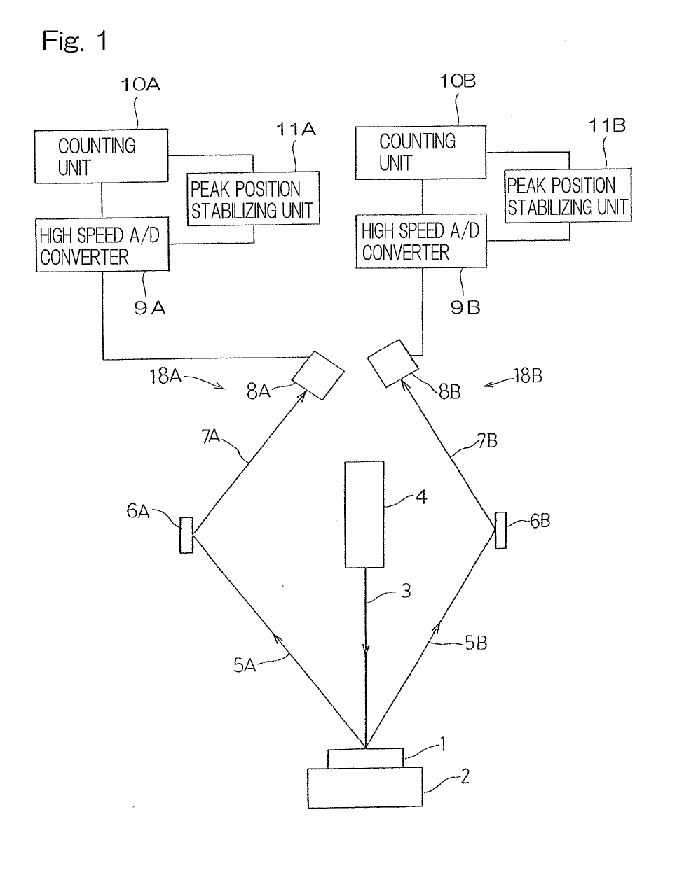

A wavelength dispersive X-ray fluorescence spectrometer designed in accordance with a preferred embodiment of the present invention will now be described in detail. The spectrometer includes, as shown in FIG. 1, detecting units 18A and 18B for respective secondary X-rays 7A and 7B such as, for example, fluorescent X-rays to be measured. Each of the detecting units 18A and 18B in turn includes a spectroscopic device 6A or 6B, a detector 8A or 8B, a high speed analog-to-digital converter 9A or 9B, a counting unit 10A or 10B and a peak position stabilizing unit 11A or 11B. In other words, this spectrometer referred to above is a wavelength dispersive X-ray fluorescence spectrometer of a simultaneous multi-elements analysis type. A preamplifier may be disposed between the detector 8A or 8B and the high speed analog-to-digital converter 9A or 9B.

Specifically, the illustrated spectrometer includes a sample support 2 on which a sample 1 is placed, an X-ray source 4 to irradiate the sample 1 with primary X-rays 3; spectroscopic devices 6A and 6B to monochromate secondary X-rays 5A and 5B emitted from the sample 1, respectively; detectors 8A and 8B, each in the form of gas flow proportional counter, to receive the secondary X-rays 7A and 7B, which have been monochromated respectively by the spectroscopic devices 6A and 6B and generating corresponding pulses, respective pulse heights of which correspond respectively to energies of the X-rays 7A and 7B, in respective numbers that correspond respectively to intensities of the X-rays 7A and 7B; and high speed analog-to-digital converters 9A and 9B to digitize respective pulses generated by the detectors 8A and 8B.

The spectrometer also includes counting units 10A and 10B, i.e., multi-channel analyzers to calculate the respective intensities of the X-rays 7A and 7B on the basis of energy spectra, each representing a distribution of counting rates relative to the pulse heights, which are respectively obtained by determining the counting rates of pulses from the high speed analog-to-digital converters 9A and 9B, which are classified for a plurality of continuous pulse height ranges, and peak position stabilizing units 11A and 11B to stabilize peak positions in the energy spectra with respect to the pulses from the high speed analog-to-digital converters 9A and 9B, respectively.

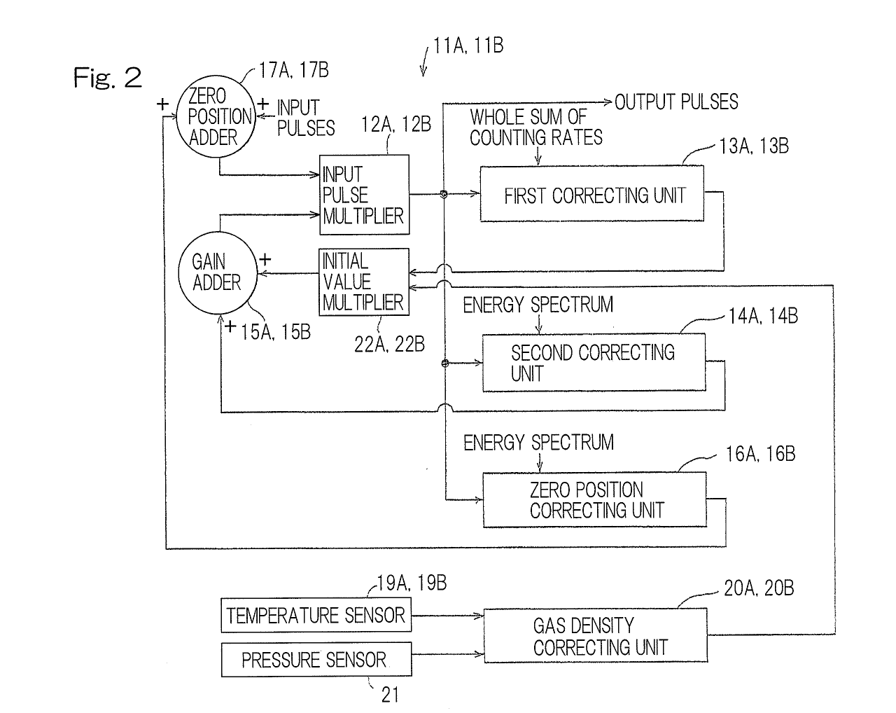

And, referring, as one example, to the peak stabilizing unit 11A associated with the secondary X-rays 7A, as shown in FIG. 2, the peak position stabilizing unit 11A includes an input pulse multiplier 12A, a first correcting unit 13A, a second correcting unit 14A and a gain adder 15A. The input pulse multiplier 12A is supplied with pulses from the high speed analog-to-digital converter 9A, changes a gain and then provides an output. In the spectrometer according to this embodiment now under discussion, the input pulses from the high speed analog-to-digital converter 9A go through a zero position adder 17A as will be described later.

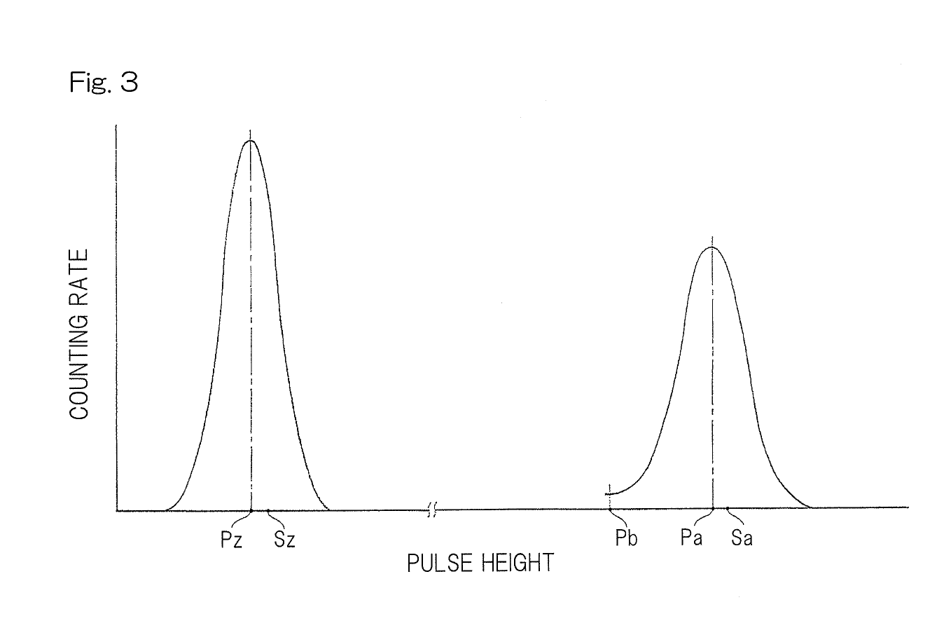

The first correcting unit 13A estimates the peak position in the energy spectrum on the basis of the whole sum of the counting rates determined by the counting unit 10A during a so-called preparatory measurement and then outputs an initial value which is a gain value required to coincide the peak position, so estimated, with a reference position. In this instance, the whole sum of the counting rates determined by the counting unit 10A is the total sum of intensities of the X-rays 7A incident on the detector 8A and is represented by an area bound between the energy spectrum, shown in a right portion of FIG. 3, and the axis of abscissas, but the spectrum used during the preparatory measurement is not necessarily limited to such a differential curve and any so-called integral curve may be employed. The peak position in the energy spectrum means the peak pulse height which is the maximum value appearing in the spectrum and is represented by, for example, a position Pa shown in the right portion of FIG. 3. The reference position referred to hereinabove is represented by a position corresponding to the original pulse height when no peak shift occur and, in the right portion of FIG. 3, corresponds to a reference position Sa for the peak position Pa.

With respect to the peak shift, since the relation between the whole sum of the counting rates determined by the counting unit 10A (based on the energy spectrum, which is the differential curve or the integral curve, as hereinbefore discussed) and the peak position in the energy spectrum is determined beforehand and the first correcting unit 13A stores therein such relation, based on the whole sum of the counting rates determined by the counting unit 10A the peak position Pa in the energy spectrum can be estimated and the initial value, which is the gain value required to coincide the estimated peak position Pa with the reference position Sa, is outputted. In this instance, in the practice of the present invention, since a dynamic gain correction value as will be described later is added to the initial value and is then fed back for correction, the accurate analysis can be accomplished even though the relation between the whole sum of the counting rates determined by the counting unit 10A and the peak position in the energy spectrum is determined strictly with respect to the individual X-ray analyzing apparatus and/or the individual detector.

The second correcting unit 14A shown in FIG. 2 detects the peak position Pa within a predetermined energy (pulse height) range, containing the reference position Sa in the energy spectrum shown in the right portion of FIG. 3, which have been obtained in the counting unit 10A, and outputs in real time the dynamic gain correction value, which is a gain value required to coincide the detected peak position Pa with the reference position Sa. In this instance, the predetermined energy range, which is a range of detection of the peak position Pa, is set with respect to the reference position Sa corresponding to the peak position Pa. It is, however, to be noted that by detecting a position Pb of a dale which is the minimum value in the energy spectrum, the peak position Pa, which is the maximum value, may be detected indirectly from a positional relation with the dale at the time of the peak position Pa being detected. Also, although not shown, by detecting a peak position of Thomson scattered X-rays of characteristic X-rays of the primary X-rays 3, which definitely appears in the energy spectrum, the peak position Pa of the secondary X-rays 7A subject to measurement may be indirectly detected from a positional relation with that peak position.

The gain adder 15A shown in FIG. 2 receives the initial value from the first correcting unit 13A and the dynamic gain correction value from the second correcting unit 14A and then adds them together before it is outputted to the input pulse multiplier 12A. In this instance, the initial value from the first correcting unit 13A is, in the case of the apparatus according to this embodiment now under discussion, inputted to the gain adder 15A through an initial value multiplier 22A as will be described later. The input pulse multiplier 12A referred to above supplies output pulses, in which the peak position has been stabilized by changing the gain of pulses from the high speed analog-to-digital converter 9A on the basis of the gain value so inputted, to the counting unit 10A. The counting unit 10A obtains an energy spectrum, in which the peak position is stabilized, based on the output pulses from the input pulse multiplier 12A and then calculates the intensity of the secondary X-rays 7A on the basis of the energy spectrum so obtained. By way of example, if the secondary X-rays 7A subject to measurement correspond to the peak value Pa in the right portion of FIG. 3, in a condition in which the peak position Pa has been stabilized, that is, in a condition in which the peak position Pa has coincided with the reference position Sa, the area bound between the energy spectrum and the axis of abscissas within the predetermined energy (pulse height) range containing the reference position Sa represents the intensity of the secondary X-rays 7A.

A peak position stabilizing unit 11B associated with the secondary X-rays 7B similarly includes an input pulse multiplier 12B, a first correcting unit 13B, a second correcting unit 14B and a gain adder 15B.

According to the basic construction of the spectrometer according to the above described embodiment of the present invention, since the first correcting units 13A and 13B and the second correcting units 14A and 14B are employed in conjunction therewith and since, even though the peak shift occurs, the initial value is outputted in an extremely short length of time, to which the dynamic gain correction value is added and is adjusted by means of a feedback, there is no necessity of waiting for the initiation of the actual measurement until the peak position, which tends to be lowered by the peak shift, is stabilized, and due to the initial value being outputted, an accurate detection can be accomplished without the peak position being lost at the time of determination of the dynamic gain correction value. Accordingly, even though the peak shift occurs, the correction can be accomplished quickly and properly and the accurate analysis can be accomplished in a short length of time.

The spectrometer according to the embodiment of the present invention hereinbefore described, the peak position stabilizing units 11A and 11B also make use of zero position correcting units 16A and 16B and the zero position adders 17A and 17B. To describe by way of the peak position stabilizing unit 11A associated with the secondary X-rays 7A, the zero position correcting unit 16A detects a zero peak position Pz at which no event level frequency peak within a predetermined energy (pulse height) range containing a zero reference position Sz, which corresponds to a zero pulse height, in the energy spectrum shown in a left portion of FIG. 3 and obtained in the counting unit 10A, and outputs a zero position gain value required to make the zero peak position Pz, so detected, to coincide with the zero reference position Sz. The zero position adder 17A shown in FIG. 2 is disposed between the high speed analog-to-digital converter 9A, shown in FIG. 1, and the input pulse multiplier 12A, so as to receive the pulse from the high speed analog-to-digital converter 9A and, also, the zero position gain value from the zero position correcting unit 16A and provides an output to the input pulse multiplier 12A after the zero position gain value has been added to the pulses from the high speed analog-to-digital converter 9A. According to the added construction related to the zero position correction, any deviation in zero position corresponding to the zero pulse height is corrected and, therefore, a further accurate analysis can be accomplished.

Since in the spectrometer according to the foregoing embodiment of the present invention, the detectors 8A and 8B, shown in FIG. 1, are employed in the form of gas flow proportional counters, and the peak position stabilizing units 11A and 11B further include temperature sensors 19A and 19B to detect respective temperatures of the detectors 8A and 8B and a pressure sensor 21 to measure a gas pressure in the detectors 8A and 8B; gas density correcting units 10A and 10B to estimate the respective peak positions Pa in the energy spectra, shown in the right portion of FIG. 3, on the basis of the respective temperatures, measured by the temperature sensors 19A and 19B, and the pressure measured by the pressure sensor 21 and to output respective gas density gain coefficients required to coincide the respective peak positions Pa, so estimated, with the respective reference positions Sa; and the initial value multipliers 22A and 22B. The initial value multipliers 22A and 22B are disposed between the first correcting units 13A and 13B and the gain adders 15A and 15B, respectively, so as to receive the respective initial values and the respective gas density gain coefficients and multiply the initial values by the gas density gain coefficients, respectively, and then provide respective outputs to the gain adders 15A and 15B.

In this instance, the temperature sensors 19A and 19B are, although not shown in FIG. 1, fitted to or in the vicinity of the associated detectors 8A and 8B. Similarly, the pressure sensors 21 should be disposed within the associated detectors 8A and 8B although not shown in FIG. 1. It is, however, to be noted that where the gas pressure inside the detectors 8A and 8B can be considered equal to the atmospheric pressure, the pressure sensor 21 may be disposed in the environment of the atmospheric pressure outside an analyzing chamber, which is held under the vacuum atmosphere and in which the detectors 8A and 8B are disposed so that the atmospheric pressure can be measured as the gas pressure of the detectors 8A and 8B. Also, regarding the respective deviations in the peak positions resulting from respective changes in gas densities of the detectors 8A and 8B, which are employed in the form of the gas flow proportional counters, since the respective relations between the temperatures, measured by the temperature sensors 19A and 19B and the pressure measured by the pressure sensor 21, and the peak positions Pa in the energy spectra shown in the right portion of FIG. 3 are determined beforehand and the gas density correcting units 20A and 20B store therein such respective relations, the respective peak positions

Pa in the energy spectra can be estimated on the basis of the temperatures, measured by the gas density correcting units 20A and 20B, and the pressure measured by the pressure sensor 21. According to the additional construction related to the gas density correction described above, since even the deviation in peak position resulting from the change in gas density of the detector 8A or 8B, which is employed in the form of the gas flow proportional counter, is corrected without using a mechanical gas density stabilizer and the initial value can be outputted accordingly, a further accurate detection is possible without losing the peak position in determining the dynamic correction value and, therefore, a further accurate analysis can be accomplished in a simplified manner.

With the spectrometer according to the foregoing embodiment of the present invention, in the additional construction related to the gas density correction described above, it includes both of the temperature sensors 19A and 19B to measure the temperatures of the detectors 8A and 8B, respectively, and the pressure sensor 21 to measure the gas pressures of the detectors 8A and 8B, such that based on both of the measured temperatures of the temperature sensors 19A and 19B and the measured pressure of the pressure sensor 21, the peak positions Pa in the energy spectra (in the right portion of FIG. 3) are estimated respectively, but in the practice of the present invention, where either one of the temperatures of the detectors or the gas pressures of the detectors may be considered constant by the reason, for example, that they are separately controlled, the additional construction related with the gas density correction described above may not require any sensor to measure such either one and the respective peak positions in the energy spectra may be estimated on the basis of the measured value(s) of the other sensor(s).

It is to be noted that either one of the additional construction related to the zero position correction or the additional construction related with the gas density correction may be provided as an additional construction. Also, although it may depart from the scope of the present invention herein set forth, an applied example may be contemplated in which the first correcting units are removed from the basic construction of the spectrometer according to the foregoing embodiment of the present invention and only the additional construction related with the gas density correction is provided as an additional construction.

Although in the foregoing description, the spectrometer according to the previously described embodiment of the present invention has been shown as and referred to as the wavelength dispersive X-ray florescence spectrometer of the simultaneous multi-elements analysis type, the present invention can be equally applicable to any other X-ray analyzing apparatus such as, for example, a wavelength dispersive X-ray fluorescence spectrometer of a scanning type, an energy dispersive X-ray fluorescence spectrometer, or an X-ray diffractometer. Also, the detector employed may be employed in the form of any detector other than the gas flow proportional counter, such as, for example, a sealed off proportional counter, a scintillation counter, or a semiconductor detector, except for that provided with the additional construction related with the gas density correction.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

### REFERENCE NUMERALS

7A, 7B . . . Incident X-rays

8A, 8B . . . Detector

9A, 9B . . . High speed analog-to-digital converter

10A, 10B . . . Counting unit

11A, 11B . . . Peak position stabilizing unit

12A, 12B . . . Input pulse multiplier

13A, 13B . . . First correcting unit

14A, 14B . . . Second correcting unit

15A, 15B . . . Gain adder

16A, 16B . . . Zero position correcting unit

17A, 17B . . . Zero position adder

19A, 19B . . . Temperature sensor

20A, 20B . . . Gas density correcting unit

21 . . . Pressure sensor

22A, 22B . . . Initial value multiplier

Pa . . . Peak position

Pz . . . Zero peak position

Sa . . . Reference position

Sz . . . Zero reference position

What is claimed is:

1. An X-ray analyzing apparatus which comprises:
a detector to generate pulses of a pulse height, corresponding to an energy of X-rays incident thereupon, in a number corresponding to an intensity of the X-rays;
a high speed analog-to-digital converter to digitize the pulses generated by the detector;
a counting unit to calculate the intensity of the X-rays on the basis of an energy spectrum representing a distribution of counting rates relative to the pulse heights, which is obtained by determining the counting rates of pulses from the high speed analog-to-digital converter, which are classified for a plurality of continuous pulse height ranges; and
a peak position stabilizing unit to stabilize a peak position in the energy spectrum with respect to the pulses from the high speed analog-to-digital converter;
in which the peak position stabilizing unit comprises:
an input pulse multiplier to which the pulses from the high speed analog-to-digital converter are inputted, the input pulse multiplier providing an output by changing a gain;
a first correcting unit to estimate the peak position in the energy spectrum on the basis of a whole sum of the counting rates determined by the counting unit and then to output an initial value, which is a gain value required to render the peak position, so estimated, to coincide with a reference position;
a second correcting unit to detect the peak position in the energy spectrum, obtained in the counting unit, within a predetermined energy range containing the reference position, and to output a dynamic gain correction value, which is a gain value required to render the peak position, so detected, to coincide with the reference position; and
a gain adder to which the initial value and the dynamic gain correction value are inputted, the gain adder to add the both together and then to output them to the input pulse multiplier.

2. The X-ray analyzing apparatus as claimed in claim 1, in which the peak position stabilizing unit comprises:
a zero position correcting unit to detect a zero peak position, at which no event level frequency peak within a predetermined energy range containing a zero reference position corresponding to a zero pulse height in the energy spectrum obtained in the counting unit and to output a zero position gain value required to render the zero peak position, so detected, to coincide with the zero reference position; and
a zero position adder disposed between the high speed analog-to-digital converter and the input pulse multiplier and to which the pulses from the high speed analog-to-digital converter and the zero position gain value are inputted, the zero position adder operable to add the zero position gain value to the pulses from the high speed analog-to-digital converter and then to output it to the input pulse multiplier.

3. The X-ray analyzing apparatus as claimed in claim 1, in which the detector is a gas flow proportional counter and in which the peak position stabilizing unit comprises:
a temperature sensor to measure a temperature of the detector and/or a pressure sensor to measure a gas pressure of the detector;
a gas density correcting unit to estimate the peak position in the energy spectrum on the basis of the temperature measured by the temperature sensor, and/or the pressure measured by the pressure sensor and then to output a gas density gain coefficient required to render the peak position, so estimated, to coincide with the reference position; and
an initial value multiplier disposed between the first correcting unit and the gain adder and to which the initial value and the gas density gain coefficient are inputted, the initial value multiplier operable to multiply the initial value by the gas density gain coefficient and then to output it to the gain adder.
